(19) United States
(12) Patent Application Publication
(10) Pub. No.: US 2012/0113271 A1
(43) Pub. Date: May 10, 2012

(54) PROCESSOR AND IMAGE PROCESSING SYSTEM USING THE SAME

(75) Inventor: Masaru Haraguchi, Kanagawa (JP)

(73) Assignee: RENESAS ELECTRONICS CORPORATION

(21) Appl. No.: 13/276,886

(22) Filed: Oct. 19, 2011

(30) Foreign Application Priority Data
Nov. 8, 2010 (JP) 2010-249584

(51) Int. Cl. H04N 5/225; G06F 9/312; G06F 15/76

(52) U.S. Cl. 348/207.1; 712/28; 712/E09.023; 712/E09.033; 348/E05.024

(57) ABSTRACT

A processor comprising groups of plural processor elements and corresponding data registers. When a first operating mode is selected, distinct data to be calculated is written to the data registers of the groups. The same data is written to the data registers of at least two groups when a second mode is selected. Calculation results from the groups are selectively outputted, and comparison between two groups outputs is made. Selection and comparison of calculation results are carried out when the first and second modes are set, respectively. Calculation results are outputted when they agree with each other; otherwise an error is produced.

### CROSS-REFERENCE TO RELATED APPLICATIONS

The disclosure of Japanese Patent Application No. 2010-249584 filed on Nov. 8, 2010 including the specification, drawings and abstract is incorporated herein by reference in its entirety.

### BACKGROUND

The present invention relates to a technique for processing an image processing application at a high speed and, in particular, to a processor for processing a large amount of data at a high speed using a calculation system of a single instruction multiple data stream (SIMD) and an image processing system using the processor.

In recent years, digital signal processing for processing a large amount of data such as sound and image data at a high speed has become more and more important. In general, a digital signal processor (DSP) as a dedicated semiconductor device is often used for such a digital signal processing. However, in a signal processing application and, in particular, in an image processing application, an amount of data to be processed is very large, so that even the DSP is insufficient in processing capacity.

On the other hand, a parallel processor technique is being developed which realizes a high signal processing performance by operating a plurality of computing units in parallel. The use of such a dedicated processor as an accelerator attached to a central processing unit (CPU) allows a high signal processing performance to be realized in a case where a low power consumption and a low cost are required like a large-scale integration (LSI) mounted on an assembly appliance.

In a case where an SIMD processor is applied to the signal and the image processing application, functions such as error detection and error correction are required to improve the reliability of calculation results. At this point, a parity determination circuit or an error check and correction (ECC) circuit are often incorporated on a data path. The inventions disclosed in the following Patent Documents 1 to 4 are known as techniques related to the above.

Patent Document 1 has a purpose to enable effectively using resources such as processor elements, realizing degradation operation, and increasing redundancy without the number of the processor elements being increased. Application programs divided into a plurality of tasks are stored in a storage medium and the tasks are overlapped on a plurality of processor elements in a CPU and are executed. The processing result of the task is transmitted and received between the processor elements via a processor-element interface to make majority decision. The task providing the processing result different from the result of the majority decision is stopped and the same task as the task is executed on the other processor elements as an alternative task. Thus, the task is taken as the unit of redundancy management.

Patent Document 2 relates to a method of utilizing information made available in a bit error check of data words belonging to instructions read into a processor having a first and a second calculating unit which operate in parallel with one another, a so-called double processor mode. The processor structure also includes a third and a fourth calculating unit intended for continuously checking for possible bit errors in read-in data words, a comparator for comparing output data from parallel operating units, a diagnostic unit adapted to determine which of the calculating units delivered correct output data when detecting a difference in output data in the comparator, and a control unit adapted to control that the output data from the processor structure originates from a calculating unit that has delivered correct output data. The processor switches to a single processor mode when a difference in output data is detected in the comparator. The data words are read directly into respective calculating units without correction for possible bit errors when the processor operates in a double processor mode, and the information from the third and fourth calculating units is used to effect said determination in the diagnostic unit. Bit error control and bit error correction are used in a known manner when the processor operates in a single processor mode.

Patent Document 3 discusses a configuration in which computing units are arranged for each SRAM array and data transfer is performed between the computing units corresponding to the memory cell arrays (entry) to execute a parallel operation.

Patent Document 4 discusses a configuration in which, in a main arithmetic circuit for executing a parallel arithmetic operation, a dynamic random-access memory (DRAM) cell array having a dynamic memory cell to store data is arranged, data transfer is executed in units of one bit or plural bits between operational circuits in which operational elements are arranged according to the pairs of the prescribed number of bit lines of the DRAM cell array and an arithmetic operation corresponding to an instruction is executed in the arithmetic element.

### [Patent Document 1]

Japanese Unexamined Patent Publication No. Hei 11 (1999)-085713

### [Patent Document 2]

Japanese Unexamined Patent Application Publication (Translation of PCT Application) No. 2001-526422

### [Patent Document 3]

Japanese Unexamined Patent Publication No. 2006-127460

### [Patent Document 4]

Japanese Unexamined Patent Publication No. 2009-098861

### SUMMARY

As described above, the parity determination circuit or the ECC circuit being arranged on the data path to improve the reliability of calculation results causes a problem that the path is lengthened to lower a frequency characteristic.

In a case where the parity determination circuit or the ECC circuit is added to a sense amplifier group (42) in FIG. 12 of Patent Document 3 or a sense amplifier (SA) in FIG. 15 of Patent Document 4, there is caused a problem that a chip area is increased or a power overhead is increased.

In the invention disclosed in Patent Document 1, if one task is processed by a plurality of processor elements, a control task is prepared to compare the process results between the plural processor elements with one another and the processing such as a task completion, a completion notification, and a coincidence determination needs to be performed in synchronization with one another. For this reason, there is also caused a problem that the procedure for synchronization is required to increase a processing time and a dedicated hardware for communicating with one another is also required to increase hardware.

The present invention has been made to solve the above problems and has its purpose to provide a processor capable of optimizing the reliability and the parallel degree of the calculation results and an image processing system using the processor.

According to an embodiment of the present invention, there is provided a processor including a plurality of processor elements (PEs) and a plurality of data registers which are provided correspondingly with the PEs and store the data and results calculated by the PEs. The PEs and the data registers are divided into a plurality of groups (PE groups).

If a normal mode is set by a CPU, distinct data to be calculated are written in the data registers of PE groups, and if an error detection mode is set by the CPU, the same data to be calculated are written in the data registers of at least two PE groups of the PE groups. Multiplexers selectively output the calculation results output from the PE groups. A determination circuit compares and determines the calculation results output from the two PE groups.

If the normal mode is set, multiplexers selectively output the calculation results output from the PE groups as distinct calculation results, and if the error detection mode is set, the determination circuit compares the calculation results output from the two PE groups with each other. If the calculation results agree with each other, the multiplexers output the calculation results and if the calculation results do not agree with each other, the determination circuit notifies the outside of the detection of an error.

According to an embodiment of the present invention, if the normal mode is set, multiplexers selectively output the calculation results output from the PE groups as distinct calculation results, and if the error detection mode is set, the determination circuit compares the calculation results output from the two PE groups with each other, so that the reliability and the parallel degree of calculation results can be optimized.

### BRIEF DESCRIPTION OF THE DRAWINGS

FIG. 1 shows a schematic diagram describing the concept of a processor according to an embodiment of the present invention;

FIG. 2 shows a block diagram illustrating the internal configuration of the processor according to the embodiment of the present invention;

FIG. 3 shows a block diagram illustrating a determination circuit 43 and an error detection/mode selection circuit 44;

FIG. 4 shows a chart describing the operation of the processor in the error detection mode;

FIG. 5 shows a chart describing the operation of the processor in the error correction mode;

FIG. 6 shows a timing chart for describing the reading operation of the data register in the normal mode;

FIG. 7 shows a timing chart for describing the reading operation of the data register in the error detection mode;

FIG. 8 shows a timing chart for describing the reading operation of the data register in the error correction mode;

FIG. 9 shows a chart in which only the data output portion of the processor operating in the normal mode is extracted according to the embodiment of the present invention;

FIG. 10 shows a chart in which only the data output portion of the processor operating in the error detection mode is extracted according to the embodiment of the present invention;

FIG. 11 shows a chart in which only the data output portion of the processor operating in the error correction mode is extracted according to the embodiment of the present invention;

FIG. 12 shows an example of a configuration of an image processing system using the processor according to the embodiment of the present invention; and

FIG. 13 is a flow chart describing the process sequence of the image processing system shown in FIG. 12.

### DETAILED DESCRIPTION

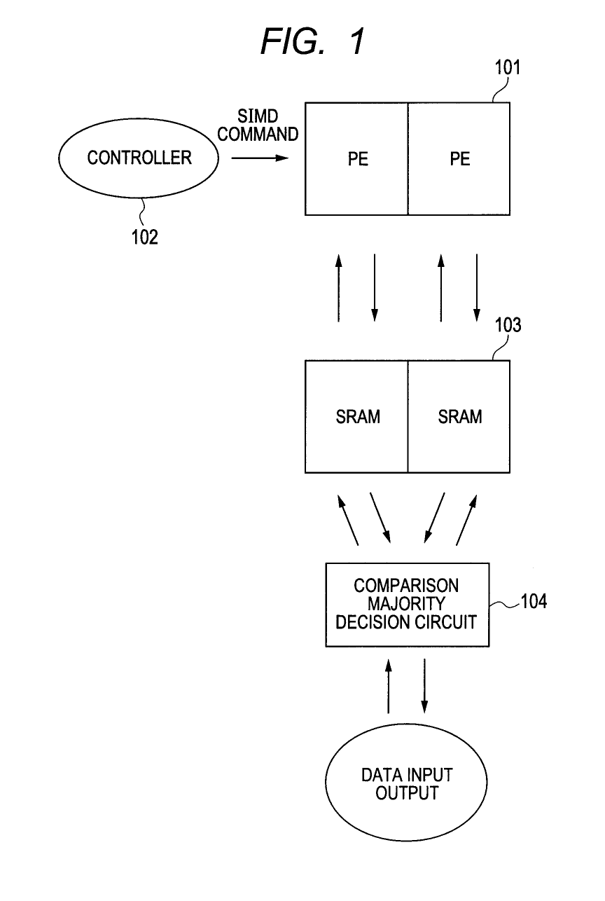

FIG. 1 shows a schematic diagram describing the concept of a processor according to an embodiment of the present invention. The processor includes a plurality of processor elements (PE) 101, a controller 102 for controlling the entire processor, a static random access memory (SRAM) 103 for storing data to be calculated by the PE 101, and a comparison majority decision circuit 104 for performing the determination of comparison/majority decision of data output from the SRAM 103.

The PE 101 receives a single-instruction multiple-data (SIMD) command from the controller 102 and calculates the data stored in the SRAM 103. The results calculated by the PE 101 are written back again to the SRAM 103.

The processor has a normal mode, an error detection mode, and an error correction mode. If the normal mode is set, the calculation results written back to the SRAM 103 are directly output outside.

If the error detection mode is set, the two calculation results written back to the SRAM 103 are compared with each other. If the two results agree with each other, it is determined that an error is not detected and the data are output outside. If the two results do not agree with each other, it is determined that an error is detected and the outside is notified of error detection.

If the error correction mode is set, the majority decision of at least three calculation results written back to the SRAM 103 is determined. If the majority decision can be made, the outside is notified of the calculation results which are the most in number. If the majority decision cannot be made, the outside is notified that error correction cannot be made.

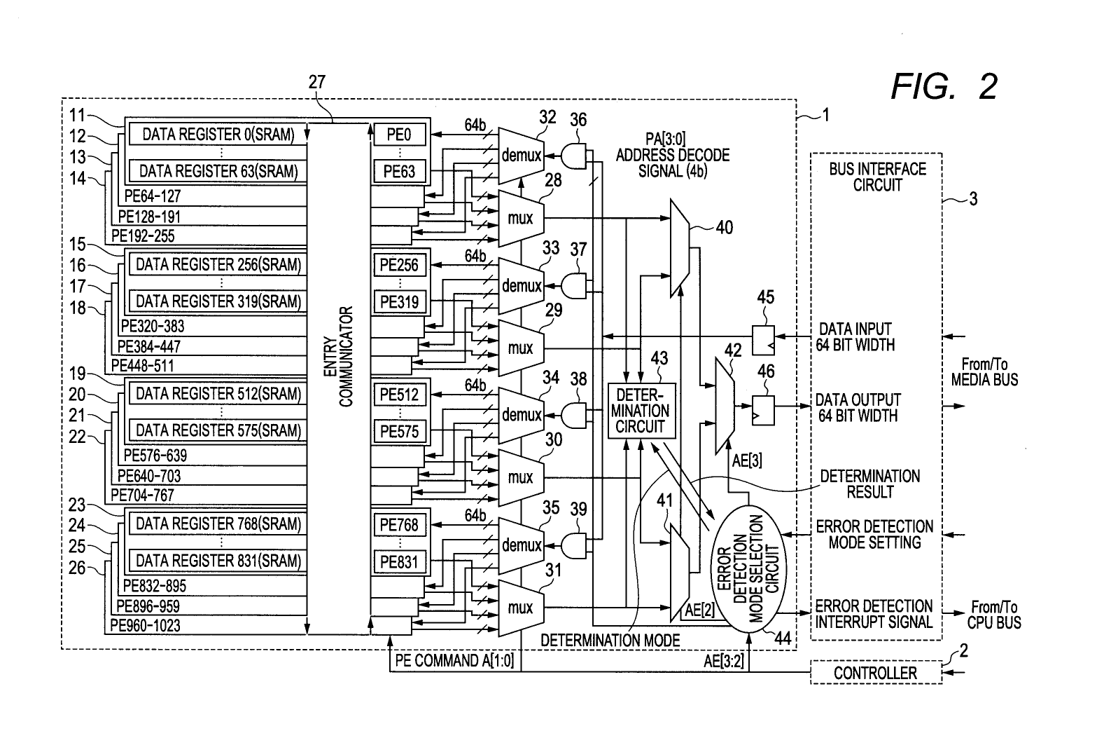

FIG. 2 shows a block diagram illustrating the internal configuration of the processor according to the embodiment of the present invention. The processor includes an arithmetic processing unit 1, a controller 2 for performing the general control of the processor, and a bus interface circuit 3.

The arithmetic processing unit 1 includes PE groups 11 to 26, an entry communicator 27, multiplexers (mux) 28 to 31, demultiplexers (demux) 32 to 35, AND circuits 36 to 39, multiplexers 40 to 42, a determination circuit 43, an error detection/mode selection circuit 44, and flip flops (hereinafter referred to as FF) 45 and 46.

The PE groups 11 to 26 each includes 64 PEs and 64 data registers (SRAMs) provided correspondingly with each of the PEs. For example, the PE group 11 includes the PEs 0 to 63 and data registers 0 to 63 corresponding thereto. The PE group 12 includes the PEs 64 to 127 and data registers 64 to 127 corresponding thereto. Similarly, the PE groups 13 to 26 each includes 64 PEs and 64 data registers. The PE groups 13 to 26 each includes 64 PEs and 64 data registers. The whole PE groups 11 to 26 include 1024 PEs (PEs 0 to 1023) and 1024 data registers (data registers 0 to 1023).

The PEs 0 to 1023 perform similar calculation according to a single PE command output from the controller 2, execute the calculation of the data stored in the corresponding data registers in the data registers 0 to 1023 and write the calculation results back to the corresponding data registers.

The entry communicator 27 can switch the connection paths of the PEs 0 to 1023 and cause the PEs 0 to 1023 to calculate data of different entry (data register).

The multiplexer 28 selects any of 64-bit data output from the PE groups 11 to 14 according to 2-bit address A[1:0] output from the controller 2 and outputs it to the multiplexer 40 and the determination circuit 43.

The multiplexer 29 selects any of 64-bit data output from the PE groups 15 to 18 according to 2-bit address A[1:0] output from the controller 2 and outputs it to the multiplexer 40 and the determination circuit 43.

The multiplexer 40 selects any of 64-bit data output from the multiplexers 28 and 29 according to 1-bit address AE[2] output from the error detection/mode selection circuit 44 and outputs it to the multiplexer 42.

The multiplexer 30 selects any of 64-bit data output from the PE groups 19 to 22 according to 2-bit address A[1:0] output from the controller 2 and outputs it to the multiplexer 41 and the determination circuit 43.

The multiplexer 31 selects any of 64-bit data output from the PE groups 23 to 26 according to 2-bit address A[1:0] output from the controller 2 and outputs it to the multiplexer 41 and the determination circuit 43.

The multiplexer 41 selects any of 64-bit data output from the multiplexers 30 and 31 according to 1-bit address AE[2] output from the error detection/mode selection circuit 44 and outputs it to the multiplexer 42.

The multiplexer 42 selects any of 64-bit data output from the multiplexers 40 and 41 according to 1-bit address AE[3] output from the error detection/mode selection circuit 44 and outputs it to the FF 46.

The FF 46 stores 64-bit data received from the multiplexer 42 and outputs them to the bus interface circuit 3. The bus interface circuit 3 outputs the 64-bit data received from the FF 46 to an after-mentioned media bus.

The FF 45 stores input data with a 64-bit width received via the bus interface circuit 3 and outputs them to the AND circuits 36 to 39.

The AND circuits 36 to 39 are provided correspondingly with the 64-bit data output from the FF 45, the data signal output from the FF 45 is coupled with one of their respective terminals, and any of an address decode signal PA[3:0] output from the error detection/mode selection circuit 44 is coupled with the other terminal thereof.

Any one of 4-bit address decode signal PA[3:0], any two thereof, or all of 4-bit are brought into a high level (hereinafter referred to as an H level) according to the mode and other bits are brought into a low level (hereinafter referred to as an L level). If only the PA[0] is at the H level, the AND circuit 36 outputs 64-bit data to the demultiplexer 32 and the 64-bit data can be written into any of the PE groups 11 to 14.

If the PA[0] and the PA[2] are at the H level, the AND circuits 36 and 38 output 64-bit data to the demultiplexers 32 and 34 and the 64-bit data can be written into any of the PE groups 11 to 14 and any of the PE groups 19 to 22. For this reason, the same 64-bit data can be written into two PE groups at the same time. Similarly, if all of the PA[0] to the PA[3] are at the H level, the same 64-bit data can be written into four PE groups at the same time.

The demultiplexer 32 outputs the 64-bit data received from the AND circuit 36 to any of the PE groups 11 to 14 according to the 2-bit address A[1:0] output from the controller 2. The PE groups receiving the data write the 64-bit data into 64 data registers.

The demultiplexer 33 outputs the 64-bit data received from the AND circuit 37 to any of the PE groups 15 to 18 according to the 2-bit address A[1:0] output from the controller 2. The PE groups receiving the data write the 64-bit data into 64 data registers.

The demultiplexer 34 outputs the 64-bit data received from the AND circuit 38 to any of the PE groups 19 to 22 according to the 2-bit address A[1:0] output from the controller 2. The PE groups receiving the data write the 64-bit data into 64 data registers.

The demultiplexer 35 outputs the 64-bit data received from the AND circuit 39 to any of the PE groups 23 to 26 according to the 2-bit address A[1:0] output from the controller 2. The PE groups receiving the data write the 64-bit data into 64 data registers.

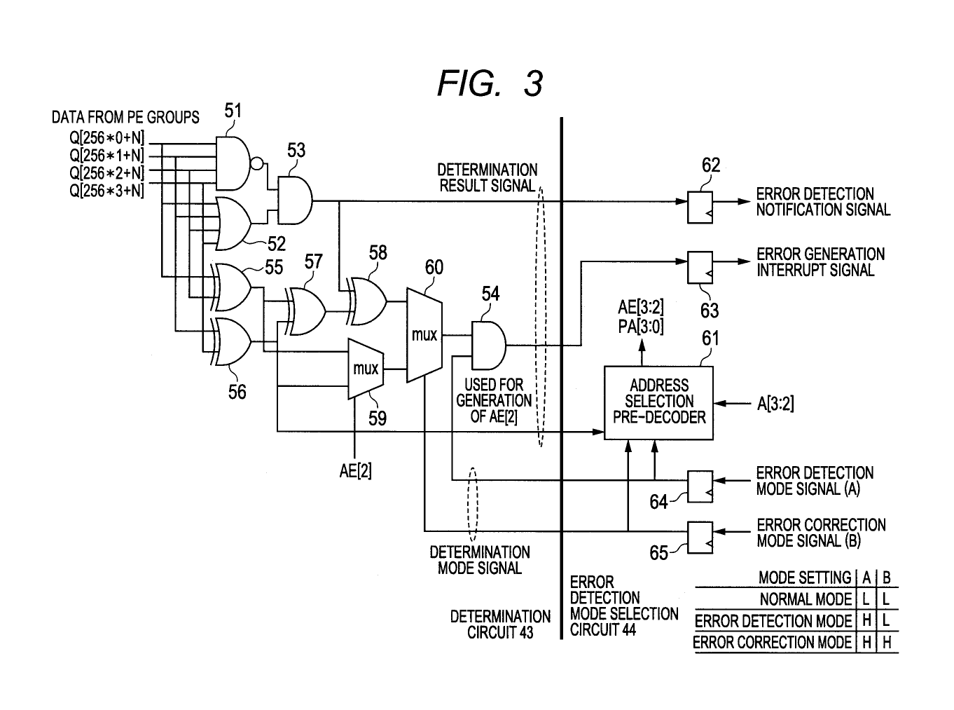

FIG. 3 shows a block diagram illustrating the determination circuit 43 and the error detection/mode selection circuit 44. The determination circuit 43 includes a NAND circuit 51, an OR circuit 52, AND circuits 53 and 54, EX-OR (exclusive OR) circuits 55 to 58, and multiplexers 59 and 60.

In FIG. 3, one bit in the 64-bit data received from each of the multiplexers 28 to 31 is subjected to comparison or majority decision, actually however, plural bits are subjected to comparison or majority decision by a plurality of similar comparison circuits.

The NAND circuit 51 outputs the L level only when all of the four data Q[256×0+N], Q[256×1+N], Q[256×2+N], and Q[256×3+N] received from the multiplexers 28 to 31 are “1” and, other than that, the NAND circuit 51 outputs the H level. The OR circuit 52 outputs the L level only when all of the four data are “0” and, otherwise, the OR circuit 52 outputs the H level.

Therefore, the AND circuit 53 outputs the L level when four data agree with one another and, otherwise, the AND circuit 53 outputs the H level. Herein, N=0 to 255.

The EX-OR circuit 55 outputs the L level when two data Q[256×0+N] and Q[256×2+N] received from the multiplexers 28 and 30 agree with each other and, otherwise, the EX-OR circuit 55 outputs the H level. The EX-OR circuit 56 outputs the L level when two data Q[256×1+N] and Q[256×3+N] received from the multiplexers 29 and 31 agree with each other and, otherwise, the EX-OR circuit 55 outputs the H level.

Therefore, the EX-OR circuit 57 outputs the L level when the two data Q[256×0+N] and Q[256×2+N] agree with each other and the two data Q[256×1+N] and Q[256×3+N] agree with each other or when neither the two data Q[256×0+N] and Q[256×2+N] agree with each other nor the two data Q[256×1+N] and Q[256×3+N] agree with each other and, otherwise, the EX-OR circuit 57 outputs the H level.

The EX-OR circuit 58 outputs the H level when the AND circuit 53 outputs the H level and the EX-OR circuit 57 outputs the L level, in other words, when two data out of four data are “0” and the other two data are “1.” In the error correction mode, the EX-OR circuit 58 outputs an error correction inability signal to the CPU described later and the error correction inability signal is used as an interrupt signal.

The EX-OR circuit 58 outputs the L level when the AND circuit 53 outputs the L level and the EX-OR circuit 57 outputs the L level, in other words, when all of the four data agree with one another. The EX-OR circuit 58 outputs the L level when the AND circuit 53 outputs the H level and the EX-OR circuit 57 outputs the H level, in other words, when three out of four data agree with one another. If an error is not detected or an error can be corrected even though it is detected, the EX-OR circuit 58 outputs the L level.

The multiplexer 59 outputs a value output from the EX-OR circuit 55, i.e., a value as to whether the data Q[256×0+N] and Q[256×2+N] agree with each other when the AE [2] is at the L level. The multiplexer 59 outputs a value output from the EX-OR circuit 56, i.e., a value as to whether the data Q[256×1+N] and Q[256×3+N] agree with each other when the AE [2] is at the H level. In the error correction mode, the multiplexer 59 outputs an error detection signal to the CPU described later and the error detection signal is used as an interrupt signal.

The multiplexer 60 selects and outputs the value output from the multiplexer 59 in the normal or the error detection mode and selects and outputs the value output from the EX-OR circuit 58 in the error correction mode.

The AND circuit 54 outputs the value output from the multiplexer 60 in the error detection or the error correction mode and outputs the L level in the normal mode. For this reason, the AND circuit 54 outputs the H level if an error is caused in the error detection mode and if an error cannot be corrected in the error correction mode and, otherwise, the AND circuit 54 outputs the L level.

The error detection/mode selection circuit 44 includes an address selection pre-decoder 61 and FFs 62 to 65. The FF 62 stores the value received from the AND circuit 53 and outputs the value as an error detection notification signal to the CPU described later. The FF 63 stores the value received from the AND circuit 54 and outputs the value as an error occurrence interrupt signal to the CPU described later.

The FF 64 stores the value of an error detection mode signal (A) and outputs the value to the AND circuit 54 and the address selection pre-decoder 61. The FF 65 stores the value of an error correction mode signal (B) and outputs the value to the multiplexer 60 and the address selection pre-decoder 61.

The error detection mode signal (A) is made to be the L level in the normal mode and made to be the H level in the error detection and the error correction mode. The error correction mode signal (B) is made to be the L level in the normal and the error detection mode and made to be the H level in the error correction mode. The these signals are set by the CPU described later.

The address selection pre-decoder 61 directly outputs the value A[3:2] to the AE[3:2] and outputs the decode results of the value A[3:2] to the PA[3:0]. Therefore, any one of the PA[0] to the PA[3] is made to be the H level and the other three PAs are made to be the L level.

The address selection pre-decoder 61 fixes the AE[3] to the L level in the error detection mode and outputs the value A[2] to the AE [2]. The address selection pre-decoder 61 outputs the H level to the PA[0] and the PA[2] in the error detection mode if the A[0] is at the L level and outputs the L level to the PA[1] and the PA[3]. The address selection pre-decoder 61 outputs the L level to the PA[0] and the PA[2] if the A[0] is at the H level and outputs the H level to the PA[1] and the PA[3].

The address selection pre-decoder 61 fixes the AE[3] to the L level in the error correction mode and outputs the AE[2] so that correct data are selected in the data output from the multiplexers 28 and 29. Furthermore, the address selection pre-decoder 61 outputs the H level to the PA[0] to the PA[3].

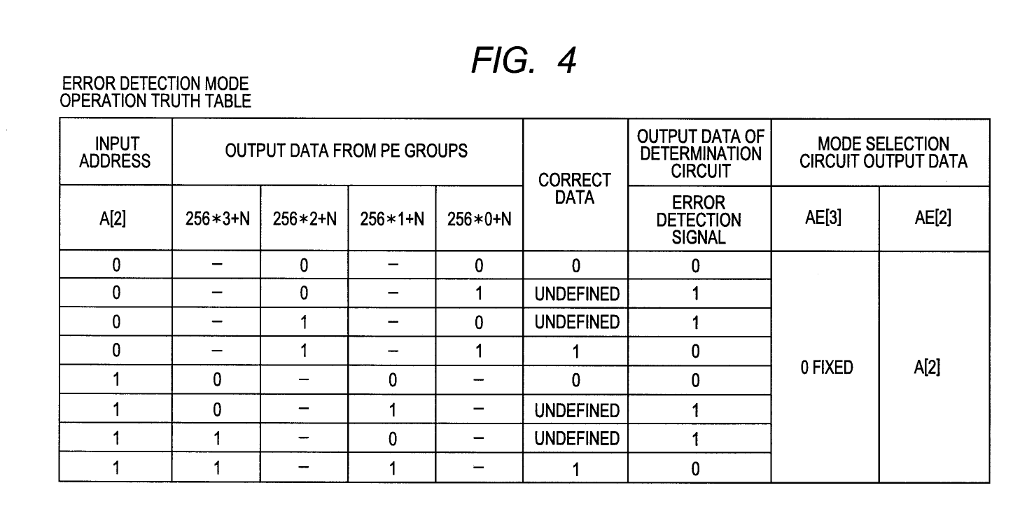

FIG. 4 shows a chart describing the operation of the processor in the error detection mode. When the address A[2] is at the L level, two data Q[256×0+N] and Q[256×2+N] are compared with each other. If the two data agree with each other, correct data are output and the L level is output to the error detection signal. If the two data do not agree with each other, data are undefined and the H level is output to the error detection signal.

When the address A[2] is at the H level, two data Q[256×1+N] and Q[256×3+N] are compared with each other. If the two data agree with each other, correct data are output and the L level is output to the error detection signal. If the two data do not agree with each other, data are undefined and the H level is output to the error detection signal.

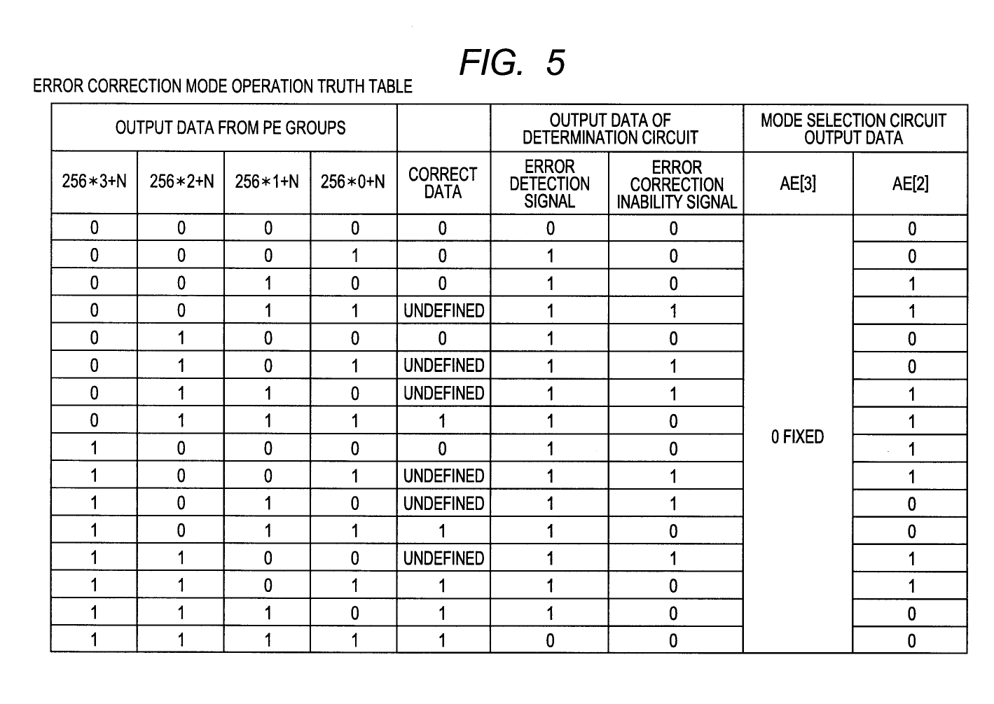

FIG. 5 shows a chart describing the operation of the processor in the error correction mode. The majority decision of Q[256×0+N], Q[256×1+N], Q[256×2+N], and Q[256×3+N] is made. If all of the four data agree with one another, correct data are output, the L level is output to the error detection signal, and the L level is output to the error correction inability signal.

When three out of the four data agree with one another, correct data are output, the H level is output to the error detection signal, and the L level is output to the error correction inability signal.

Otherwise, data are undefined, the H level is output to the error detection signal and the H level is output to the error correction inability signal.

In FIG. 5, an example is described in which the majority decision of Q[256×0+N], Q[256×1+N], Q[256×2+N], and Q[256×3+N] is made. When all of two or more output data would hardly cause an error, for example, the majority decision can be made based on the three data without considering one out of the four data. More specifically, this can be achieved such that the NAND circuit 51 and the OR circuit 52 are changed to three-input ones so that the value of the data Q[256×3+N] output from the PE group is not input to the determination circuit 43 and change is made so that input of the EX-OR 56 is received from the Q[256×3+N]. In this case, the state does not occur where the H level is output to the error correction inabililty signal (the state where correct data are undefined), so that the processor is operated based on the first to the third, the fifth, the eighth, the ninth, twelfth, fourteenth, and the sixteenth lines of an error correction mode operation truth table.

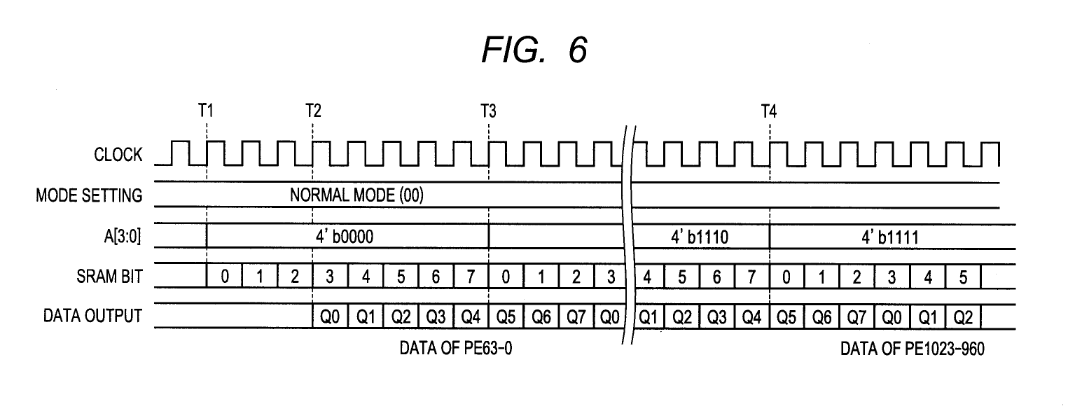

FIG. 6 shows a timing chart for describing the reading operation of the data register in the normal mode. Data arithmetically processed according to a single PE command are written back to the 1024 data registers (0 to 1023) by the PEs (0 to 1023) corresponding thereto before T1. Eight-bit data (SRAM bit 0 to 7) are stored in each of the 1024 data registers (0 to 1023). An example is described below in which the eight-bit data are sequentially read. At T1, “4'b0000” is output to the address A[3:0] and the PE group 11 starts outputting data. First, data corresponding to the SRAM bit 0 of the 64 data registers in the PE group 11 are read and output to the multiplexer 28. After that, data are sequentially read in the order of the SRAM bits 1, 2, 3, . . . , and 7 and output to the multiplexer 28. As a result, data of a total of 64 bits×8 bits are output.

At T2, the output data Q0 corresponding to the SRAM bit 0 in the PE group 11 are output from the multiplexer 28 and output data are output in the order of Q1, Q2, Q3, . . . , and Q7.

At T2, “4'b0001” is output to the address A[3:0] and the PE group 12 starts outputting data. First, data corresponding to the SRAM bit 0 of the 64 data registers in the PE group 12 are read and output to the multiplexer 28. After that, data are sequentially read in the order of the SRAM bits 1, 2, 3, . . . , and 7 and output to the multiplexer 28.

The similar operation is repeated. At T4, “4'b1111” is output to the address A[3:0] and the PE group 26 starts outputting data. First, data corresponding to the SRAM bit 0 of the 64 data registers in the PE group 26 are read and output to the multiplexer 31. After that, data are sequentially read in the order of the SRAM bits 1, 2, 3, . . . , and 7 and output to the multiplexer 31.

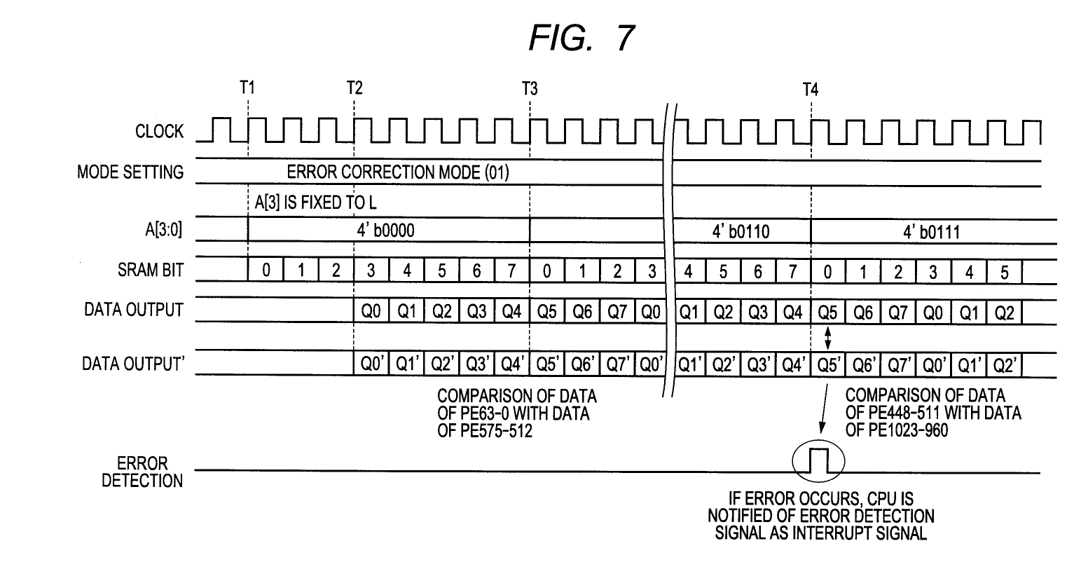

FIG. 7 shows a timing chart for describing the reading operation of the data register in the error detection mode. Data arithmetically processed according to a single PE command are written back to the 1024 data registers (0 to 1023) by the PEs (0 to 1023) corresponding thereto before T1. Eight-bit data (SRAM bit 0 to 7) are stored in each of the 1024 data registers (0 to 1023). An example is described below in which the eight-bit data are sequentially read. Unlike in the normal mode, data with the same value in the data registers of the PE groups 11 to 18 are written in the data registers of the PE groups 19 to 26 respectively. At T1, “4'b0000” is output to the address A[3:0] and the PE groups 11 and 19 start outputting data. First, data corresponding to the SRAM bit 0 of the 64 data registers in the PE groups 11 and 19 are read and output to the multiplexers 28 and 30 respectively. After that, data are sequentially read in the order of the SRAM bits 1, 2, 3, . . . , and 7 and output to the multiplexers 28 and 30. As a result, data of a total of 64 bits×8 bits are output from each of the PE groups 11 and 19.

At T2, the output data Q0 and Q0′ corresponding to the SRAM bit 0 in the PE groups 11 and 19 are output from the multiplexers 28 and 30 respectively. At this point, the determination circuit 43 compares the output data Q0 and Q0′ with each other. Similarly, the determination circuit 43 sequentially compares the output data Q1 to Q7 and Q1′ to Q7′ output from the PE groups 11 and 19 via the multiplexers with each other.

At T3, “4'b0001” is output to the address A[3:0] and the PE groups 12 and 20 start outputting data. First, data corresponding to the SRAM bit 0 of the 64 data registers in the PE groups 12 and 20 are read and output to the multiplexers 28 and 30 respectively. After that, data are sequentially read in the order of the SRAM bits 1, 2, 3, . . . , and 7 and output to the multiplexers 28 and 30.

The similar operation is repeated. At T4, “4'b0111” is output to the address A[3:0] and the PE groups 18 and 26 start outputting data. First, data corresponding to the SRAM bit 0 of the 64 data registers in the PE groups 18 and 26 are read and output to the multiplexers 29 and 31. After that, data are sequentially read in the order of the SRAM bits 1, 2, 3, . . . , and 7 and output to the multiplexers 29 and 31. At this point, the determination circuit 43 compares the output data output from the two PE groups. If the determination circuit 43 detects that the output data do not agree with each other, the determination circuit 43 outputs the H level to the error detection signal. In FIG. 7, an example is shown in which it is supposed that “4'b0110” is output to the address A[3:0] immediately before T4 and, at T4, the determination circuit 43 compares the output data Q5 output from the PE group 17 via the multiplexer 29 with the output data Q5′ output from the PE group 25 via the multiplexer 31, as a result, the determination circuit 43 detects that the output data Q5 does not agree with the output data Q5′, and the H level is output to the error detection signal.

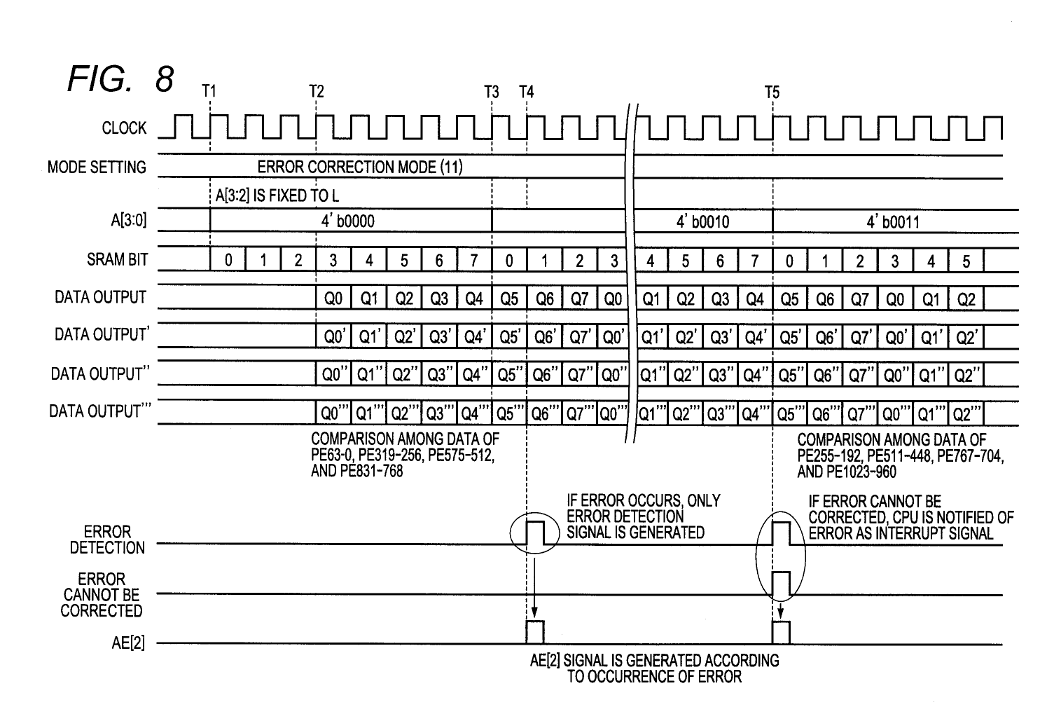

FIG. 8 shows the timing chart for describing the reading operation of the data register in the error correction mode. Data arithmetically processed according to a single PE command are written back to the 1024 data registers (0 to 1023) by the PEs (0 to 1023) corresponding thereto before T1. Eight-bit data (SRAM bit 0 to 7) are stored in each of the 1024 data registers (0 to 1023). An example is described below in which the eight-bit data are sequentially read. Unlike in the normal mode, data with the same value in the data registers of the PE groups 11 to 14 are written in the data registers of the PE groups 15 to 18, the data registers of the PE groups 19 to 22, and the data registers of the PE groups 23 to 26 respectively. At T1, “4'b0000” is output to the address A[3:0] and the PE groups 11, 15, 19, and 23 start outputting data. First, data corresponding to the SRAM bit 0 of the 64 data registers in the PE groups 11, 15, 19, and 23 are read and output to the multiplexers 28, 29, and 31 respectively. After that, data are sequentially read in the order of the SRAM bits 1, 2, 3, . . . , and 7 and output to the multiplexers 28, 29, 30 and 31. As a result, data of a total of 64 bits×8 bits are output from each of the PE groups 11, 15, 19 and 23.

At T2, the output data Q0, Q0′, Q0″, and Q0″′ corresponding to the SRAM bit 0 in the PE groups 11, 15, 19 and 23 are output from the multiplexers 28, 29, 30, and 31 respectively. At this point, the determination circuit 43 makes the majority decision of the output data Q0, Q0′, Q0″, and Q0″′. Similarly, the determination circuit 43 sequentially makes the majority decision of the output data Q1 to Q7, Q1′ to Q7′, Q1″ to Q7″ and Q1″′ to Q7″′ output from the PE groups 11, 15, 19 and 23 via the multiplexers.

At T3, “4'b0001” is output to the address A[3:0] and the PE groups 16, 20, and 24 start outputting data. First, data corresponding to the SRAM bit 0 of the 64 data registers in the PE groups 12, 16, 20, and 20 are read and output to the multiplexers 28, 29, 30, and 31 respectively. After that, data are sequentially read in the order of the SRAM bits 1, 2, 3, . . . , and 7 and output to the multiplexers 28, 29, 30, and 31.

At T4, the determination circuit 43 detects that one of the output data Q6, Q6′, Q6″, and Q6″′ does not agree with the others and outputs the H level to the error detection signal. However, an error can be corrected, so that the determination circuit 43 outputs the L level to the error correction inability signal. The error detection/mode selection circuit 44 outputs the address AE[2] so that correct data are selected.

The similar operation is repeated. At T5, “4'b0011” is output to the address A[3:0] and the PE groups 14, 18, 22, and 26 start outputting data. First, data corresponding to the SRAM bit 0 of the 64 data registers in the PE groups 14, 18, 22, and 26 are read and output to the multiplexers 28, 29, 30, and 31. After that, data are sequentially read in the order of the SRAM bits 1, 2, 3, . . . , and 7 and output to the multiplexers 28, 29, 30, and 31. At this point, the determination circuit 43 detects that the majority decision of the output data Q5, Q5′, Q5″, and Q5″′ cannot be made and outputs the H level to the error detection signal. Since an error cannot be corrected, the determination circuit 43 outputs the H level to the error correction inability signal. In FIG. 8, an example is shown in which it is supposed that “4′0010” is output to the address A[3:0] immediately before T5 and, at T5, the determination circuit 43 detects that the majority decision cannot be made among the output data Q5 output from the PE group 13 via the multiplexer 28, the output data Q5′ output from the PE group 17 via the multiplexer 29, the output data Q5″ output from the PE group 21 via the multiplexer 30, and the output data Q5″′ output from the PE group 25 via the multiplexer 31, outputs the H level to the error detection signal, and outputs the H level to the error correction inability signal.

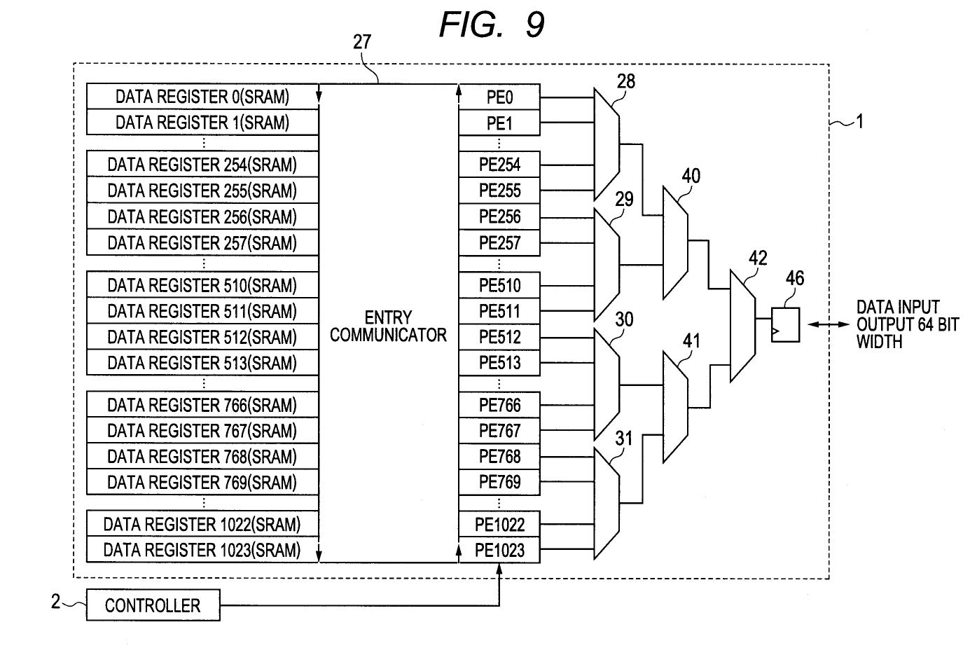

FIG. 9 shows a chart in which only the data output portion of the processor operating in the normal mode is extracted according to the embodiment of the present invention. As shown in FIG. 9, the PEs 0 to 1023 calculate data different from one another, the multiplexers 28 to 31 and 40 to 42 sequentially perform selection and the FF 46 outputs 64-bit width data. In this case, since different data are provided for all PEs, the processor has a high parallelism and calculation performance.

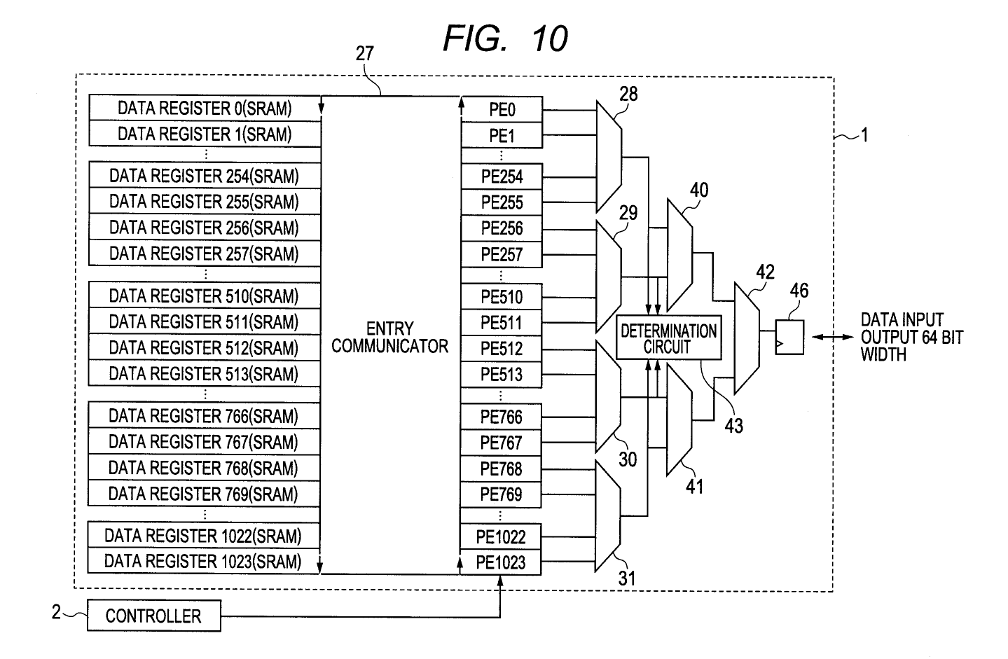

FIG. 10 shows a chart in which only the data output portion of the processor operating in the error detection mode is extracted according to the embodiment of the present invention. As shown in FIG. 10, the PEs 0 to 511 and the PEs 512 to 1023 calculate the same data and the comparison circuit (determination circuit) 43 compares two data and performs determination. At this point, the entry to be subjected to comparison and determination is physically separated by 512 entries to lower the probability that the two data cause a soft error, improving an error detection ratio at the time when the soft error is caused.

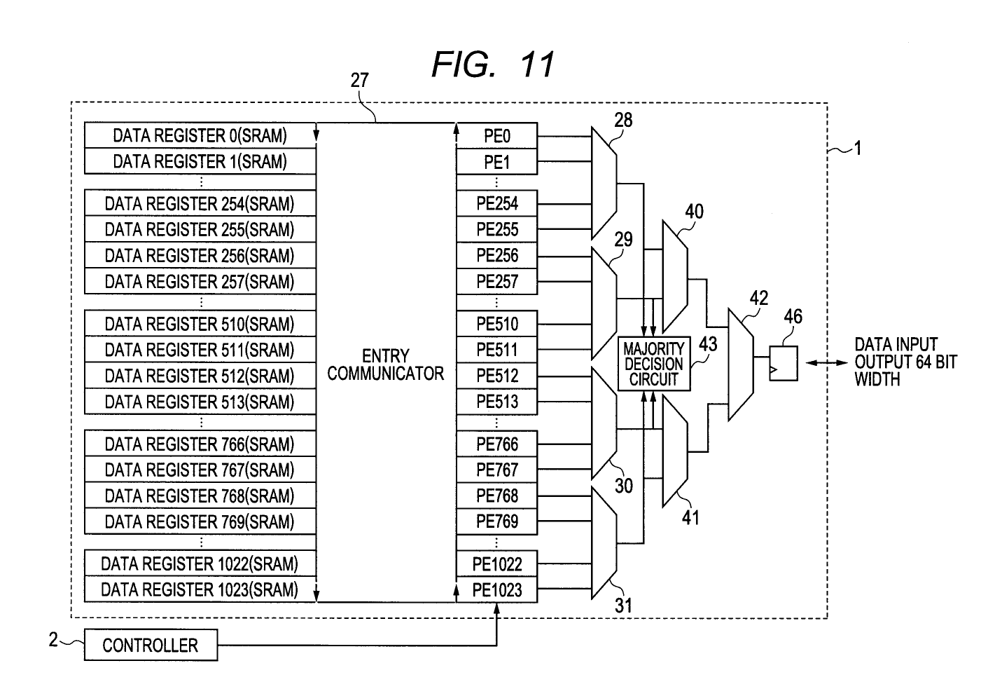

FIG. 11 shows a chart in which only the data output portion of the processor operating in the error correction mode is extracted according to the embodiment of the present invention. As shown in FIG. 11, the PEs 0 to 255, 256 to 511, 512 to 767, and 768 to 1023 calculate the same data and the majority decision circuit (determination circuit) 43 makes the majority decision of four data. At this point, the entry to be subjected to the majority decision is physically separated by 256 entries to lower the probability that two or more out of the four data cause a soft error, improving an error detection ratio at the time when the soft error is caused and enabling the error to be corrected by the majority decision.

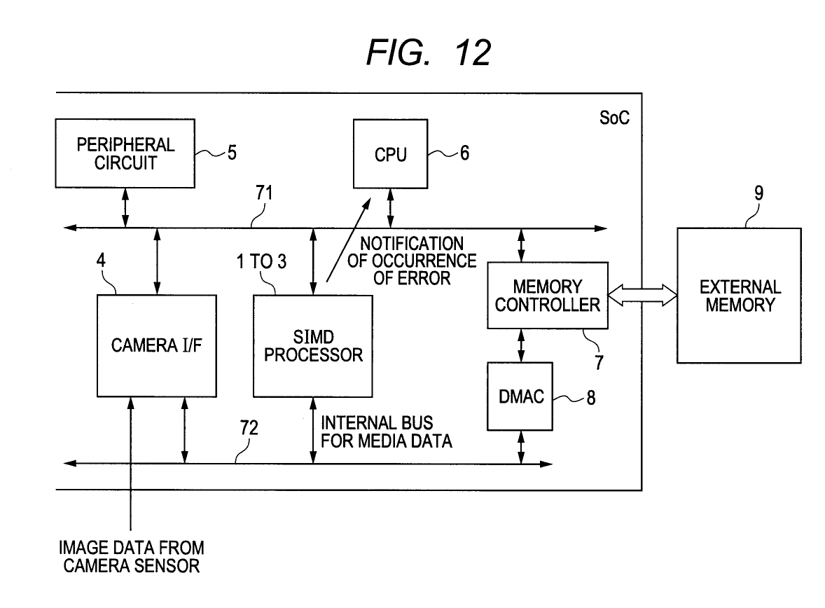

FIG. 12 shows an example of a configuration of an image processing system using the processor according to the embodiment of the present invention. The image processing system is realized as a system on chip (SoC) and includes the SIMD processor (the arithmetic processing unit 1, the controller 2, and the bus interface circuit 3) shown in FIG. 2, a camera I/F 4, a peripheral circuit 5, a CPU 6, a memory controller 7, and direct memory access controller (DMAC) 8.

The CPU 6 controls the entire image processing system. For example, the CPU 6 writes data in the data registers 0 to 1023 of the arithmetic processing unit 1 in the SIMD processor and issues PE command to the PEs 0 to 1023 to cause the PEs to perform calculation. The operation of the arithmetic processing unit 1 has already been described above. The CPU 6 receives the error detection notification signal, the error detection signal, and the error correction inability signal from the SIMD processors (1 to 3) and performs processing according to the signals.

The camera I/F 4 receives image data from a camera sensor (not shown) and outputs them to a CPU bus 71 or a media bus 72.

The memory controller 7 receives image data from the camera I/F 4 via the CPU bus 71 and writes the image data in an external memory 9. The memory controller 7 receives the image data or process results from the camera I/F 4 or the SIMD processors (1 to 3) by DMA transfer of the DMAC 8 and can write them in the external memory 9. Furthermore, the memory controller 7 reads the image data stored in the external memory 9 in response to a request from the CPU 6 and outputs the image data in the CPU 6 or the SIMD processors (1 to 3).

A peripheral circuit 5 is comprised of a timer, a serial I/F, and an interrupt controller and data can be input to and output from the peripheral circuit 5 via an I/O port. The DMAC 8 transfers data between the camera I/F 4 or the peripheral circuit 5 and the external memory 9 in response to a request from the CPU 6.

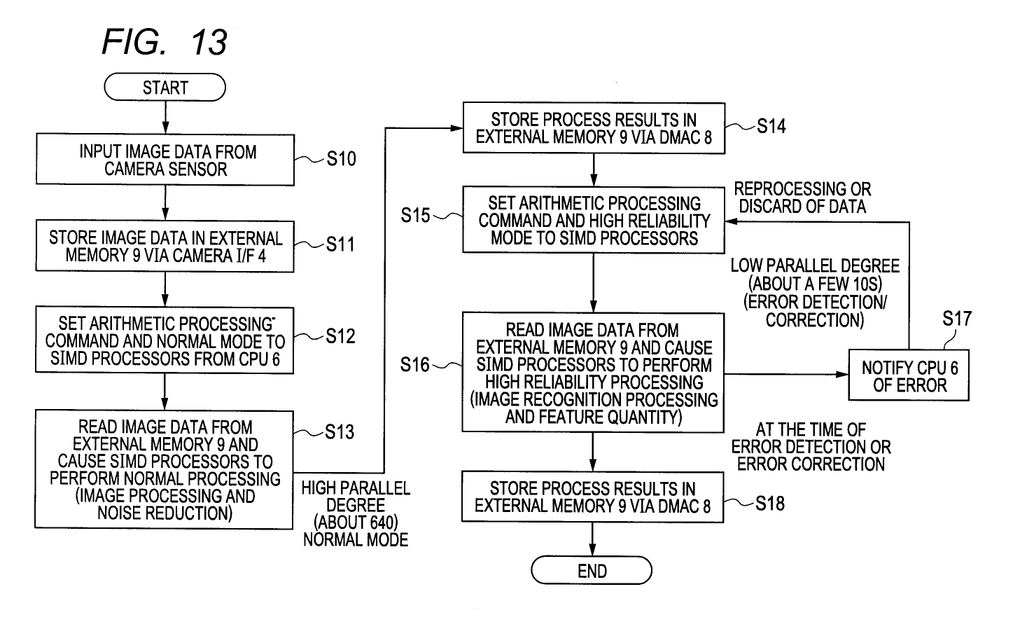

FIG. 13 is a flow chart describing the process sequence of the image processing system shown in FIG. 12. When image data are input from the camera sensor not shown (step S10), the camera I/F 4 stores the image data in the external memory 9 (step S11).

The CPU 6 sets an arithmetic processing command and the normal mode to the SIMD processors (1 to 3) (step S12). The CPU 6 reads the image data from the external memory 9, writes the image data in the data registers 0 to 1023 of the SIMD processors (1 to 3), and causes the SIMD processors (1 to 3) to perform the normal processing (step S13). The normal processing refers to a filter processing such as a noise reduction on the whole image or offset processing in which not so high reliability is required. In this case, processing can be performed at a high parallelism.

The results processed by the SIMD processors (1 to 3) are stored in the external memory 9 via the DMAC 8 (step S14).

The CPU 6 sets an arithmetic processing command and a high reliability mode (the error detection mode or the error correction mode) to the SIMD processors (1 to 3) (step S15). The CPU 6 reads the image data from the external memory 9, writes the image data in the data registers 0 to 1023 of the SIMD processors (1 to 3), and causes the SIMD processors (1 to 3) to perform the high reliability processing (step S16). The high reliability processing refers to an image recognition processing in which a specific area is subjected to a threshold processing or labeling processing and it is recognized that what an object is from the obtained feature quantity, which requires high reliability. In this case, the high reliability processing is lower in parallelism than the normal processing but the reliability of process results can be improved.

If an error can be neither detected nor corrected, the CPU 6 is notified that an error can be neither detected nor corrected (step S17), and the re-processing or the discard of data is performed in consideration of real-time capability. If an error cannot be detected, but can be corrected, the results processed by the SIMD processors (1 to 3) are stored in the external memory 9 via the DMAC 8 (step S18).

If the image processing system is used as an on-vehicle equipment, the whole image data input from an on-vehicle camera are subjected to filter processing or offset processing. However, information from the camera sensor includes noises, so that a bit error can be tolerated and the reliability required is not so high, for this reason, the processing is performed in the normal mode. In this process, a large amount of data needs to be calculated, so that parallelism is increased by the normal mode and the data can be processed at a high speed.

On the other hand, in the process for extracting a feature from a specific range such as a white line recognition, although the number of data themselves is not so large, the extraction of a different feature due to bit error is not allowable, so that the process is performed in the error detection mode or in the error correction mode. If calculation cannot be executed again due to restrictions on real-time capability or the discard of calculation results is not allowed because the continuity of data is important, the error correction mode is effective to perform the process.

It is possible to cause the SMID processor itself to perform the determination process of the determination circuit 43 shown in FIG. 2. In this case, the determination process is realized by software.

As described above, according to the processor of the present embodiment, in a case where the normal mode is set, distinct data are written in the data registers of the PE groups 11 to 26 to cause the PEs to perform the calculation process, in case where the error detection mode is set, the same data are written in the data registers of the PE groups 11 to 18 and 19 to 26 to cause the PEs to perform the calculation process, and the calculation results are compared with each other to detect whether an error occurs. This consequently allows the optimization of the reliability and parallelism of the calculation results.

In case where the error correction mode is set, the same data are written in the data registers of the PE groups 11 to 14, 15 to 18, 19 to 22, and 23 to 26 to cause the PEs to perform the calculation process, and the error correction is performed by the majority decision, which becomes adaptable to applications which are required of real-time capability and important in the continuity of data.

The error detection/error correction circuit is removed from the data path being a critical path to allow the frequency characteristic to be prevented from being lowered.

An error in data can be detected and corrected only by the comparison and majority decision circuits to allow the amount of hardware to be reduced.

An error is detected and corrected only at the time of outputting calculation results to allow power consumption to be reduced.

The disclosed embodiment is not restrictive but an example in all respects. The scope of the present invention is shown not by the above description, but by claims and intends to include meaning equivalent to the claims and all changes in the claims.

In particular, the SRAM is used as the data register, however, a nonvolatile memory such as a magnetoresistive random access memory (MRAM) or a flash memory or a volatile memory such as a DRAM may be used.

What is claimed is:

1. A processor comprising:
a plurality of processor elements; and
a plurality of data registers which are provided correspondingly with the processor elements and store the data to be calculated by the processor elements and results calculated by the processor elements,
the processor elements and the data registers being divided into a plurality of groups,
the processor comprising:
a writing means which writes distinct data to be calculated in the data registers of the groups when a first mode is set by the outside, and which writes the same data to be calculated in the data registers of at least two groups of the groups when a second mode is set by the outside;
a selection means which selectively outputs the calculation results output from the groups; and
a determination means which compares and determines the calculation results output from at least the two groups;
wherein when the first mode is set, the selection means selectively outputs the calculation results output from the groups as distinct calculation results, and when the second mode is set, the determination means compares the calculation results output from at least the two groups,
wherein when the calculation results agree with each other, the selection means outputs the calculation results, and when the calculation results do not agree with each other, the determination means notifies the outside of the detection of an error.

2. The processor according to claim 1,
wherein when a third mode is set from the outside, the writing means writes the same data in the data registers of at least three groups of the groups and the determination means makes the majority decision of the calculation results output from at least the three groups, and
wherein when the majority decision can be made, the selection means outputs the calculation results, and when the majority decision cannot be made, the determination means notifies the outside that an error cannot be corrected.

3. The processor according to claim 2,
wherein when the first mode is set, the writing means writes distinct data to be calculated in the data registers of the groups,
wherein when the second mode is set, the writing means simultaneously writes the same data to be calculated in the data registers of at least the two groups, and
wherein when a third mode is set, the writing means simultaneously writes the same data to be calculated in the data registers of at least the three groups.

4. The processor according to claim 2,
wherein the processor elements and the data registers are divided into four groups, and
wherein the selection means includes:
a first selector for selecting either of calculation results output from a first group and calculation results output from a second group and outputting the selected calculation results;
a second selector for selecting either of calculation results output from a third group and calculation results output from a fourth group and outputting the selected calculation results; and
a third selector for selecting either of calculation results output from the first group and calculation results output from the second group and outputting the selected calculation results,
the processor further comprising a control means,
wherein when the first mode is set, the controlling means controls the first to third selectors to sequentially output the calculation results output from the first to fourth groups, and
wherein when the second mode is set, the controlling means controls the first and third selectors to output the calculation results output from the first group if the determination means determines that the calculation results output from the first group agree with the calculation results output from the third group, and controls the first and third selectors to output the calculation results output from the second group if the determination means determines that the calculation results output from the second group agree with the calculation results output from the fourth group.

5. The processor according to claim 4,
wherein when the third mode is set, and when the determination means determines that the majority decision of the calculation results output from the first to fourth groups can be made, the control means controls the first to third selectors to output data whose majority decision can be made.

6. An image processing system comprising:
a first processor including a plurality of processor elements and a plurality of data registers which are provided correspondingly with the processor elements and store the data to be calculated by the processor elements and results calculated by the processor elements;
a camera interface for inputting the image data captured by a camera sensor; and
a second processor for issuing a command to the first processor to cause the first processor to calculate the image data input by the camera interface,
the processor elements and the data registers being divided into a plurality of groups,
wherein the first processor includes:
a writing means which writes distinct data to be calculated in the data registers of the groups when a first mode is set by the second processor, and which writes the same data to be calculated in the data registers of at least two groups of the groups when a second mode is set by the second processor;
a selection means for selectively outputting the calculation results output from the groups; and
a determination means for comparing and determining the calculation results output from at least the two groups,
wherein, when the first mode is set, the selection means selectively outputs the calculation results output from the groups as distinct calculation results, and
wherein, when the second mode is set, the determination means compares the calculation results output from at least the two groups, and when the calculation results agree with each other, the selection means outputs the calculation results, and when the calculation results do not agree with each other, the determination means notifies the outside of the detection of an error.
